(19) United States
(12) Patent Application Publication
(10) Pub. No.: US 2025/0174947 A1
(43) Pub. Date: May 29, 2025

(54) TRACK MAGNETIC ATTRACTION POWER CONNECTION STRUCTURE

(71) Applicant: E-LITE LIGHTING CO., LTD., Shenzhen (CN)

(72) Inventor: Pengrui WANG, Shenzhen (CN)

(21) Appl. No.: 18/614,347

(22) Filed: Mar. 22, 2024

(30) Foreign Application Priority Data
Nov. 27, 2023 (CN) 2023231948749

(51) Int. Cl. H01R 25/14; F21V 23/06; H01R 13/62; H01R 13/627; H01R 13/631; H01R 13/633

(52) U.S. Cl. CPC H01R 25/142; H01R 13/6205; H01R 13/6273; H01R 13/6315; H01R 13/633; H01R 25/145; F21V 23/06

(57) ABSTRACT

A track magnetic attraction power connection structure includes a track and a quick connector; the track is provided with a sliding groove, the sliding groove is internally provided with an iron base plate, and the iron base plate is provided with a conductive strip; the quick connector is provided with a magnet and a power connection assembly, the quick connector is capable of being inserted into the sliding groove, and the magnet attracts the iron base plate, thereby enabling the power connection assembly to abut against the conductive strip such that an electrical connection is achieved; the present invention has a reasonable structure; the quick connector is capable of being inserted into the sliding groove on any side of the track, the magnet attracts the iron base plate such that the quick connector is connected to the track.

### TECHNICAL FIELD

This invention generally relates to the technical field of lighting fixtures, and more particularly, to a track magnetic attraction power connection structure.

### BACKGROUND

A lighting fixture is conventionally fixedly installed on a wall surface or a suspended ceiling. A table light is restricted by the length of a power cord and the position of a socket although it is capable of moving within a limited range. To achieve the purpose of atmosphere creation, the illumination area of an atmosphere light needs to be frequently adjusted. However, it is difficult for conventional fixing and installing methods to meet the demand of flexibly installing atmosphere lights. Presently, there is a large amount of research on the track-installation of atmosphere light products, aiming to achieve a flexible installation of atmosphere lights by means of a track.

Chinese patent CN209944254U discloses a track connector and a track light, comprising a housing, a first conductive member, a second conductive member, a knob assembly, a button switch device, a first communicating member, a second communicating member and a driving power supply, wherein the first conductive member and the second conductive member are arranged in the housing, the first conductive member has a first contact piece, and the second conductive member has a second contact piece. Two opposite side walls of the housing are respectively provided with a first opening and a second opening. The knob assembly is rotatably connected to the housing, and the knob assembly is configured to enable the first contact piece and the second contact piece to respectively extend out from the housing or retract into the housing from the first opening and the second opening. The knob assembly comprises a knob, and the knob is arranged at an upper end surface of the housing. The first communicating member and the second communicating member are arranged in the housing, and the second communicating member is configured to form an electrical connection with the second conductive member.

The structure of the conventional track connector is complex. First, the track connector needs to be fixedly installed on the track; second, the first contact piece and the second contact piece are controlled to extend out from the housing or retract into the housing from the first opening and the second opening by means of the knob assembly; and finally, the first communicating piece and the second communicating piece interact to form an electrical connection. The aforesaid structure results in difficult assembly and disassembly, inconvenient adjustment of installation position, complex structure and high cost.

Therefore, it is urgent to develop a novel track-installation structure.

### SUMMARY

The purpose of the present invention is to provide a track magnetic attraction power connection structure, which has a reasonable structure and is capable of being flexibly adjusted and conveniently assembled and disassembled.

To achieve the above purpose, the present invention adopts the following technical solution: a track magnetic attraction power connection structure comprising a track and a quick connector, wherein the track is provided with a sliding groove, the sliding groove is internally provided with an iron base plate, and the iron base plate is provided with a conductive strip, wherein the quick connector is provided with a magnet and a power connection assembly, the quick connector is capable of being inserted into the sliding groove, and the magnet attracts the iron base plate, thereby enabling the power connection assembly to abut against the conductive strip such that an electrical connection is achieved.

In another embodiment of the present invention, there are two sliding grooves, and the two sliding grooves are respectively arranged on two opposite side walls of the track.

In another embodiment of the present invention, the power connection assembly comprises an electrode plate, and the electrode plate is fixedly arranged in the quick connector. The electrode plate is provided with power connection terminals, and the power connection terminals pass through a first side wall of the quick connector and are arranged on the first side wall of the quick connector.

In another embodiment of the present invention, the power connection terminal comprises two elastic pins, and the two elastic pins are spaced apart from each other. A first end of the elastic pin is fixedly connected to the electrode plate, and a second end of the elastic pin penetrates out from and is arranged on the first side wall of the quick connector.

In another embodiment of the present invention, an inner wall of the first side wall of the quick connector is provided with two magnets, the electrode plate and the first side wall of the quick connector are arranged in parallel, and the two magnets are symmetrically arranged on two sides of the electrode plate.

In another embodiment of the present invention, the quick connector is provided with a locking structure, and two inner side walls of the sliding groove are respectively provided with a locking groove. The locking structure is connected to the locking groove in an interacting manner, thereby enabling the quick connector to be connected to the track in an interacting manner while achieving adjustable installation of the quick connector along the sliding groove.

In another embodiment of the present invention, the locking structure comprises two protruding keys, key holes are formed in a third side wall and a fourth side wall of the quick connector, and the two protruding keys are movably arranged in corresponding key holes in a penetrating manner. When the protruding key protrudes out from the key hole, the protruding key is slidably connected with the locking groove.

In another embodiment of the present invention, the locking structure further comprises an unlocking bracket, and the unlocking bracket is in transmission connection with the two protruding keys. The unlocking bracket is capable of propelling the two protruding keys to retract into the key holes, or the unlocking bracket releases the two protruding keys such that the two protruding keys protrude out from the key holes.

In another embodiment of the present invention, the second side wall of the quick connector is provided with a support.

Compared with the prior art, the present invention has the following advantages: the present invention has a reasonable structure; the quick connector is capable of being inserted into the sliding groove on any side of the track, the magnet attracts the iron base plate such that the quick connector is connected to the track; moreover, the attraction force ensures the stability of the connection between the power connection assembly and the conductive strip, and the quick connector is capable of sliding along the sliding groove to change the position of installation, thereby effectively improving the convenience of disassembly and adjustment of a lighting fixture or electric appliance.

### BRIEF DESCRIPTION OF THE DRAWINGS

FIG. 1 is a schematic diagram illustrating an overall structure of the present invention before assembly;

FIG. 2 is a schematic diagram illustrating a sectional view of the present invention after assembly;

FIG. 3 is a schematic diagram illustrating a top view of the quick connector of the present invention;

In Figures: 1—Track, 2—Quick Connector, 11—Sliding Groove, 12—Iron Base Plate, 13—Conductive Strip, 14—Locking Groove, 21—Magnet, 22—Electrode Plate, 23—Elastic Pin, 24—Protruding Key, 25—Key Hole, 26—Unlocking Bracket, 27—Support.

### DETAILED DESCRIPTION

Drawings and embodiments are combined hereinafter to further elaborate the technical solution of the present invention.

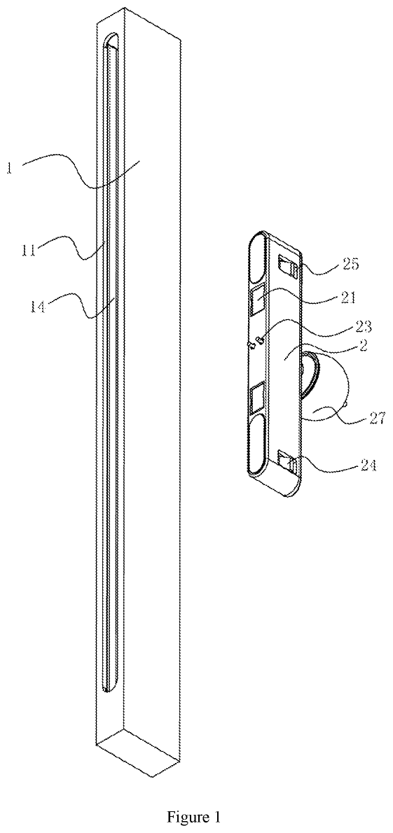

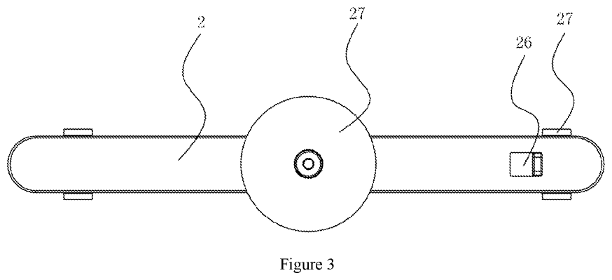

Referring to FIGS. 1-3, the track magnetic attraction power connection structure of the present invention comprises a track 1 and a quick connector 2, wherein the track 1 is provided with a sliding groove 11, the sliding groove 11 is internally provided with an iron base plate 12, and the iron base plate 12 is provided with a conductive strip 13. The quick connector 2 is provided with a magnet 21 and a power connection assembly, the quick connector 2 is capable of being inserted into the sliding groove 11, and the magnet 21 attracts the iron base plate 12, thereby enabling the power connection assembly to abut against the conductive strip 13 such that an electrical connection is achieved. There are two sliding grooves 11, and the two sliding grooves 11 are respectively arranged on two opposite side in walls of the track 1. The sliding groove 11, the iron base plate 12 and the conductive strip 13 are all arranged along the length direction of the track 1, and the quick connector 2 is capable of being installed at any position in the sliding groove 11 of the track 1 or moving along the sliding groove 11 to achieve adjustable installation, so that the installation and use of products such as a lighting fixture and an electric appliance are facilitated. The two sides of the track 1 are provided with the sliding grooves 11, the openings of the sliding grooves 11 are formed in the horizontal direction, and the conductive strips 13 are arranged on both sides of the iron base plate 12. It is worth mentioning that, at least two conductive strips 13 are arranged on any side of the iron base plate 12 to respectively form a live wire and a neutral wire. The quick connector 2 is inserted into the sliding groove 11 along the horizontal direction of the sliding groove 11, and the magnet 21 attracts the iron base plate 12 to form a structural interaction, thereby preventing the quick connector 2 from sliding out from the sliding groove 11, and further, the magnet 21 is capable of propelling the quick connector 2 to get close to the iron base plate 12, so that the power connection assembly is in close contact with the conductive strip 13 to form an electrical connection.

The power connection assembly comprises an electrode plate 22, and the electrode plate 22 is fixedly arranged in the quick connector 2. The electrode plate 22 is provided with power connection terminals, and the power connection terminals pass through a first side wall of the quick connector 2. A first end of the power connection terminal is electrically connected to the electrode plate 22, and when the quick connector 2 is inserted into the sliding groove 11, second ends of two groups of power connection terminals respectively abut against a positive electrode conductive strip 13 and a negative electrode conductive strip 13 to form an electrical connection.

The power connection terminal comprises two elastic pins 23, and the two elastic pins 23 are spaced apart from each other. A first end of the elastic pin 23 is fixedly connected to the electrode plate 22, and a second end of the elastic pin 23 penetrates out from and is arranged on the first side wall of the quick connector 2. Preferably, the power connection terminal is provided with elastic pins, and when the quick connector 2 is inserted into the sliding groove, the elastic pin 23 abuts against the conductive strip 13, and the magnet 21 attracts the iron base plate 12. In this way, the quick connector 22 imposes an acting force on the iron base plate 12, which makes the connection between the elastic pin 23 and the conductive strip 13 become more stable. Further, any one of the power connection terminals is provided with two elastic pins 23, thereby ensuring that the electrode plate 22 always forms an electrical connection with the conductive strip 13 when any elastic pin 23 fails.

An inner wall of the first side wall of the quick connector 2 is provided with two magnets 21, the electrode plate 22 and the first side wall of the quick connector 2 are arranged in parallel, and the two magnets 21 are symmetrically arranged on two sides of the electrode plate 22. The two magnets 21 are symmetrically arranged on two sides of the electrode plate 22, which allows the elastic pins 23 to be uniformly stressed such that the stability of connection is ensured.

The quick connector 2 is provided with a locking structure, two inner side walls of the sliding groove 11 are respectively provided with a locking groove 14, and the locking structure is connected to the locking groove 14 in an interacting manner. Through adopting this arrangement, the quick connector 2 is connected to the track 1 in an interacting manner, and adjustable installation of the quick connector 2 along the sliding groove 11 is achieved. The locking structure is configured to prevent the quick connector from accidentally falling off when a failure occurs between the magnet 21 and the iron base plate 12. The locking structure merely prevents the quick connector 2 from falling off from the sliding groove 11, and the quick connector 2 slides along the track 1 through the interaction between the locking structure and the locking groove 14, thereby adjusting the installing position of the quick connector 2 in the track 1.

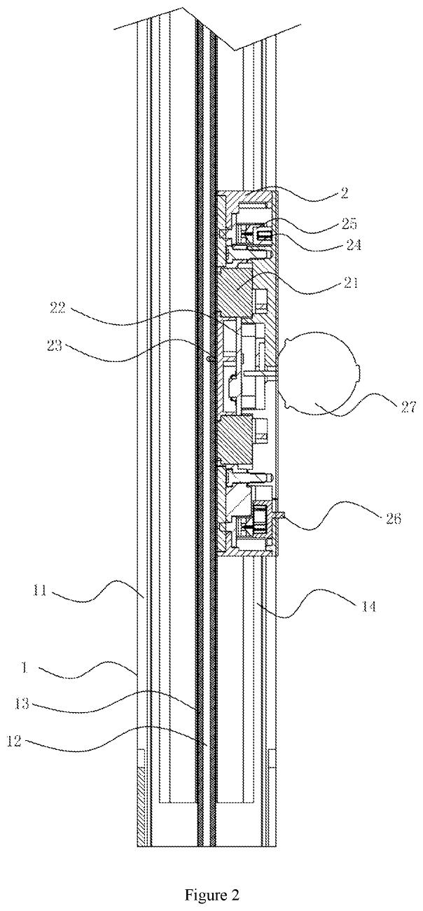

Referring to FIG. 2, the locking structure comprises two protruding keys 24, key holes 25 are formed in a third side wall and a fourth side wall of the quick connector 2, and the two protruding keys 24 are movably arranged in corresponding key holes 25 in a penetrating manner. When the protruding key 24 protrudes out from the key hole 25, the protruding key 24 is slidably connected with the locking groove 14. The protruding key 24 is embedded into the locking groove 14 for interacting with the locking groove 14 in a sliding manner, and the quick connector 2 may be inserted into any sliding groove 11 from two sides. Correspondingly, the protruding key 24 and the locking groove 14 are connected in the longitudinal direction in an interacting manner, which allows the protruding key 24 to slide up and down along the locking groove 14.

The locking structure further comprises an unlocking bracket 26, and the unlocking bracket 26 is in transmission connection with the two protruding keys 24. The unlocking bracket 26 is capable of propelling the two protruding keys 24 to retract into the key holes 25, or the unlocking bracket 26 releases the two protruding keys 24 such that the two protruding keys 24 protrude out from the key holes 25. The unlocking bracket 26 propels the protruding keys 24 to extend out from or retract into the key holes 25 by adopting conventional means such as a buckle or a connecting rod, thereby locking the quick connector 2 in the sliding groove 11 or allowing the quick connector 2 to be unlocked and removed from the track 1.

The second side wall of the quick connector 2 is provided with a support 27. It should be understood that, the electrode plate 22 needs to be electrically connected to a lighting fixture or an electric appliance, and the quick connector 2 should have a connecting wire. Certainly, the support 27 may also be provided with an electrical connection structure in a contact manner, which enables the electrode plate 22 to be electrically connected to the lighting fixture or electric appliance.

The above are merely preferred embodiments of the present invention, and therefore, all equivalent changes or modifications made according to the structures, features and principles described within the scope defined by the claims of the present invention shall fall into the protection scope of the present invention.

1. A track magnetic attraction power connection structure, comprising:
a track (1), and
a quick connector (2), wherein the track (1) is provided with at least one sliding groove (11), the sliding groove (11) is internally provided with an iron base plate (12), and the iron base plate (12) is provided with a conductive strip (13), wherein the quick connector (2) is provided with a magnet (21) and a power connection assembly, the quick connector (2) is capable of being inserted into the sliding groove (11), and the magnet (21) attracts the iron base plate (12), thereby enabling the power connection assembly to abut against the conductive strip (13) such that an electrical connection is achieved.

2. The track magnetic attraction power connection structure of claim 1, wherein the track (1) is provide with two sliding grooves (11), and the two sliding grooves (11) are respectively arranged on two opposite side walls of the track (1).

3. The track magnetic attraction power connection structure of claim 1, wherein the power connection assembly further comprises an electrode plate (22), and the electrode plate (22) is fixedly arranged in the quick connector (2), wherein the electrode plate (22) is provided with power connection terminals, and the power connection terminals pass through a first side wall of the quick connector (2) and are arranged on the first side wall of the quick connector (2).

4. The track magnetic attraction power connection structure of claim 3, wherein the power connection terminal further comprises two elastic pins (23), and the two elastic pins (23) are spaced apart from each other, wherein a first end of the elastic pin (23) is fixedly connected to the electrode plate (22), and a second end of the elastic pin (23) penetrates out from and is arranged on the first side wall of the quick connector (2).

5. The track magnetic attraction power connection structure of claim 3, wherein an inner wall of the first side wall of the quick connector (2) is provided with two magnets (21), the electrode plate (22) and the first side wall of the quick connector (2) are arranged in parallel, and the two magnets (21) are symmetrically arranged on two sides of the electrode plate (22).

6. The track magnetic attraction power connection structure of claim 1, wherein the quick connector (2) is provided with a locking structure, and two inner side walls of the sliding groove (11) are respectively provided with a locking groove (14), wherein the locking structure is connected to the locking groove (14) in an interacting manner, thereby enabling the quick connector (2) to be connected to the track (1) in an interacting manner while achieving adjustable installation of the quick connector (2) along the sliding groove (11).

7. The track magnetic attraction power connection structure of claim 6, wherein the locking structure further comprises:
two protruding keys (24), key holes (25) are formed in a third side wall and a fourth side wall of the quick connector (2), and the two protruding keys (24) are movably arranged in corresponding key holes (25) in a penetrating manner, wherein when the protruding key (24) protrudes out from the key hole (25), the protruding key (24) is slidably connected with the locking groove (14).

8. The track magnetic attraction power connection structure of claim 7, wherein the locking structure further comprises:
an unlocking bracket (26), and the unlocking bracket (26) is in transmission connection with the two protruding keys (24), wherein the unlocking bracket (26) is capable of propelling the two protruding keys (24) to retract into the key holes (25), or the unlocking bracket 26 releases the two protruding keys (24) such that the two protruding keys (24) protrude out from the key holes (25).

9. The track magnetic attraction power connection structure of claim 3, wherein the second side wall of the quick connector (2) is provided with a support (27).
